(19) United States
(12) Patent Application Publication
(10) Pub. No.: US 2020/0260366 A1
(43) Pub. Date: Aug. 13, 2020

(54) INFORMATION BROWSING SYSTEM, INFORMATION BROWSING METHOD AND PORTABLE TERMINAL

(71) Applicant: PANASONIC INTELLECTUAL PROPERTY MANAGEMENT CO., LTD., Osaka (JP)

(72) Inventors: Yoshiki YAMAMOTO, Kanagawa (JP); Takashi MUKAIYAMA, Kanagawa (JP); Shingo TSUKIHARA, Tokyo (JP); Yuji NAGAISHI, Kanagawa (JP); Koichi AIHARA, Kanagawa (JP)

(73) Assignee: PANASONIC INTELLECTUAL PROPERTY MANAGEMENT CO., LTD., Osaka (JP)

(21) Appl. No.: 16/339,632

(22) PCT Filed: Sep. 27, 2017
(86) PCT No.: PCT/JP2017/034847

§ 371 Date: Apr. 4, 2019

(30) Foreign Application Priority Data
Oct. 17, 2016 (JP) 2016-203484

(51) Int. Cl. H04W 48/16; H04M 1/725; H04W 88/08; H04W 48/20

(52) U.S. Cl. CPC H04W 48/16; H04M 1/72577; H04W 48/20; H04W 88/08; H04M 1/72572

(57) ABSTRACT

Regarding display of browsing information on a portable terminal, it is possible to impose a browsing restriction on a person who does not have a browsing authorization with a simple configuration while avoiding a hindrance to easy access to the browsing information. An information browsing system includes: one or more transmitters that respectively transmit wireless signals including transmitter identification information which is identification information of the transmitter toward a target area; a portable terminal that holds terminal identification information and receives the wireless signal; a storage that accumulates browsing information isplayable on the portable terminal; and a server that provides the browsing information to the portable terminal by communicably connecting to the portable terminal, in which at least one of the portable terminal and the server determines whether or not to display the browsing information on the portable terminal based on a combination of the transmitter and terminal identification information.

### TECHNICAL FIELD

The present disclosure is related to an information browsing system, an information browsing method, and a portable terminal for browsing information to be restricted for browsing in the portable terminal, and is specifically related to an information browsing system, an information browsing method, and a portable terminal for browsing medical information by a patient or the like in a hospital.

### BACKGROUND ART

For example, in an information browsing system in a medical field, medical information of a patient is accumulated as electronic information by an electronic medical record or the like, and a health professional such as a doctor or a nurse accesses to an information device such as a server or the like via a network, from a terminal used by himself/herself, so that the medical information of the patient can be appropriately displayed on the terminal.

In the related art, as this type of system, for example, there is provided a medical information provision system including a portable terminal having a wireless interface, a plurality of access points capable of wirelessly communicating with the portable terminal, and a server capable of wirelessly communicating with the portable terminal via any of the plurality of access points (see PTL 1). The portable terminal is connected to any of the plurality of access points and automatically notifies the server of an identifier of the connected access point, and monitors an access point identifier of an access point different from the connected access point at the same time. Based on the access point identifier notified from the portable terminal, the server refers to area information stored in association with the access point identifier and provides medical information to the portable terminal based on the referenced area information.

### CITATION LIST

### Patent Literature

PTL 1: JP 5187754 B2

### SUMMARY OF THE INVENTION

According to the related art described in PTL 1, the health professional can quickly access to a database without requesting a character input or a read operation of an identification (ID) when referring to the medical information by using the portable terminal.

On the other hand, in some cases, regarding medical information of a patient, the patient wants to browse the information of the patient within a range not interfering in a medical practice or the like (a range excluding information to be kept confidential to the patient), so that there is a need an information browsing system for this patient. However, in the related art, since it is not assumed that the patient may browse the medical information, in a case of applying the related art to the medical information being browsed by the patient, there is a possibility that a person who does not have a browsing authorization may browse the medical information of another person and personal information of the patient is not protected.

In addition, not only the case where the patient browses the medical information of the patient but also in an information browsing system used for other purposes, it is desirable to impose a browsing restriction on a person who does not have a browsing authorization with a simple configuration while avoiding a hindrance to easy access to browsing information (that is, information to be browsed by a user of the portable terminal) from the portable terminal.

The present disclosure is provided in view of the problem in the related art, and regarding display of browsing information on a portable terminal, an aspect of the present disclosure is to provide an information browsing system, an information browsing method, and the portable terminal capable of imposing a browsing restriction on a person who does not have a browsing authorization with a simple configuration while avoiding a hindrance to easy access to browsing information.

According to the present disclosure, there is provided an information browsing system including: one or more transmitters that are disposed in association with any of one or more target areas set in advance and respectively transmit wireless signals including transmitter identification information which is identification information of the transmitter, toward the corresponding target area; a portable terminal that holds terminal identification information which is identification information of the portable terminal and receives the wireless signal; a storage that accumulates browsing information able to be displayed on the portable terminal; and a server that provides the browsing information to the portable terminal by communicably connecting to the portable terminal via a network, in which at least one of the portable terminal and the server determines whether or not to display the browsing information on the portable terminal based on a combination of the transmitter identification information and the terminal identification information.

According to the present disclosure, regarding display of browsing information on a portable terminal, it is possible to impose a browsing restriction on a person who does not have a browsing authorization with a simple configuration while avoiding a hindrance to easy access to the browsing information.

### BRIEF DESCRIPTION OF DRAWINGS

FIG. 1 is an overall configuration diagram of an information browsing system according to a first embodiment.

FIG. 2 is a functional block diagram of the information browsing system illustrated in FIG. 1.

FIG. 3 is a hardware configuration diagram of a server illustrated in FIG. 1.

FIG. 4 is a hardware configuration diagram of a portable terminal illustrated in FIG. 1.

FIG. 5 is a flowchart illustrating a flow until a browsing operation start in an information browsing process in the portable terminal illustrated in FIG. 1.

FIG. 6 is a flowchart illustrating a flow until an information provision start in an information provision process of the server illustrated in FIG. 1.

FIG. 7 is a sequence diagram illustrating a process such as communication or the like of each of units until an information provision start in the information browsing system illustrated in FIG. 1.

FIG. 8 is an explanatory diagram illustrating an example of a management table related to S1008 in FIG. 7.

FIG. 9 is an explanatory diagram illustrating a modification example of the management table illustrated in FIG. 8.

FIG. 10 is an explanatory diagram illustrating an example of an application top screen related to S1013 in FIG. 7.

FIG. 11 is an explanatory diagram illustrating an example of an authentication screen related to S1015 in FIG. 7.

FIG. 12 is an explanatory diagram illustrating an example of a case where the portable terminal receives a plurality of beacon signals.

FIG. 13 is a functional block diagram of an information browsing system according to a second embodiment.

FIG. 14 is a flowchart illustrating a flow until a browsing operation start in an information browsing process in a portable terminal according to the second embodiment.

FIG. 15 is a flowchart illustrating a flow until an information provision start in an information provision process of a server according to the second embodiment.

### DESCRIPTION OF EMBODIMENTS

According to a first invention for solving the problem, there is provided an information browsing system including: one or more transmitters that are disposed in association with any of one or more target areas set in advance and respectively transmit wireless signals including transmitter identification information which is identification information of the transmitter, toward the corresponding target area; a portable terminal that holds terminal identification information which is identification information of the portable terminal and receives the wireless signal; a storage that accumulates browsing information able to be displayed on the portable terminal; and a server that provides the browsing information to the portable terminal by communicably connecting to the portable terminal via a network, in which at least one of the portable terminal and the server determines whether or not to display the browsing information on the portable terminal based on a combination of the transmitter identification information and the terminal identification information.

In this manner, since whether or not to display the browsing information on the portable terminal is determined based on the combination of the transmitter identification information included in the wireless signal from the transmitter and the terminal identification information held by the portable terminal, regarding display of the browsing information on the portable terminal, it is possible to impose a browsing restriction on a person who does not have a browsing authorization with a simple configuration while avoiding a hindrance to easy access to the browsing information (for example, without requiring an input of a password for confirming the browsing authorization, reading an IC tag, or the like).

According to a second invention for solving the problem, regarding permission area information indicating the target area in which the browsing information is permitted to be browsed, the at least one of the portable terminal and the server refers to a first management table in which one or more combinations of the transmitter identification information and the terminal identification information are registered, and determines to display the browsing information on the portable terminal in a case where the combination of the transmitter identification information and the terminal identification information is included in the first management table.

In this manner, when determining whether or not to display the browsing information on the portable terminal, since the first management table in which the combination of the transmitter identification information and the terminal identification information are registered for the permission area information is referred to, it becomes easy to manage a browsing restriction (browsing permission) on each of the target areas.

According to a third invention for solving the problem, the server transmits browsing information selected according to the permission area information from a plurality of pieces of the browsing information accumulated in the storage, to the portable terminal.

In this manner, since the browsing information selected according to the permission area information is transmitted from the server to the portable terminal, it is possible to more rapidly access from the portable terminal to the browsing information.

According to a fourth invention for solving the problem, user attribute information of the portable terminal is included in the selected browsing information.

In this manner, a user who uses the portable terminal can easily confirm that the browsing information is own information of the user.

According to a fifth invention for solving the problem, regarding prohibition area information indicating the target area in which the browsing information is prohibited from being browsed, at least one of the portable terminal and the server refers to a second management table in which one or more pieces of the transmitter identification information are registered, and determines not to display the browsing information on the portable terminal in a case where the transmitter identification information is included in the second management table.

In this manner, when determining whether or not to display the browsing information on the portable terminal, since the second management table in which the transmitter identification information is registered for the prohibition area information is referred to, it becomes easy to manage a browsing restriction (browsing prohibition) on each of the target areas.

According to a sixth invention for solving the problem, in a case where a plurality of pieces of the transmitter identification information to be used for the determination exist and the at least one of the plurality of pieces of the transmitter identification information is included in the second management table, at least one of the portable terminal and the server determines not to display the browsing information on the portable terminal.

In this manner, even in a case where the portable terminal receives the wireless signals from the plurality of different transmitters (that is, the plurality of pieces of the transmitter identification information are obtained), regarding display of the browsing information on the portable terminal, it becomes possible to stably impose a browsing restriction on the target area in which the browsing information is prohibited from being browsed.

According to a seventh invention for solving the problem, in a case where a plurality of pieces of the transmitter identification information to be used for the determination exist, the at least one of the portable terminal and the server refers to radio wave intensities of the wireless signals including the plurality of pieces of the transmitter identification information respectively and selects one piece of the transmitter identification information included in the wireless signal having a larger radio wave intensity, as information to be used for the determination.

In this manner, even in a case where the portable terminal receives the wireless signals from the plurality of different transmitters, regarding display of the browsing information on the portable terminal, it is possible to stably impose a browsing restriction by selecting one piece of the transmitter identification information based on a magnitude of the radio wave intensity of the wireless signal.

According to an eighth invention for solving the problem, in a case where the at least one of the portable terminal and the server determines not to display the browsing information on the portable terminal, the portable terminal displays an authentication screen of a user.

In this manner, as described above, by allowing the browsing operation of an authorized user by using the authentication screen of the user as an exception of the browsing restriction, it is possible to improve convenience of displaying the browsing information on the portable terminal while sacrificing the simple access to the browsing information to some extent.

According to a ninth invention for solving the problem, in a case where the portable terminal is unable to obtain the transmitter identification information, the at least one of the portable terminal and the server determines not to display the browsing information on the portable terminal.

In this manner, it is possible to more easily impose a browsing restriction based on the presence or absence of obtainment of the transmitter identification information by the portable terminal.

According to a tenth invention for solving the problem, there is provided an information browsing method including: a transmission step of respectively transmitting, by one or more transmitters disposed in association with any of one or more target areas set in advance, wireless signals including transmitter identification information which is identification information of the transmitter toward the corresponding target area; a reception step of receiving, by a portable terminal that holds terminal identification information which is identification information of the portable terminal, the wireless signal; an information providing step of providing, by a server communicably connected to the portable terminal via a network, browsing information to the portable terminal, in which before the information providing step is executed, at least one of the portable terminal and the server determines whether or not to display the browsing information on the portable terminal based on a combination of the transmitter identification information and the terminal identification information.

In this manner, since whether or not to display the browsing information on the portable terminal is determined based on the combination of the transmitter identification information included in the wireless signal from the transmitter and the terminal identification information held by the portable terminal, regarding display of the browsing information on the portable terminal, it is possible to impose a browsing restriction on a person who does not have a browsing authorization with a simple configuration while avoiding a hindrance to easy access to the browsing information.

According to an eleventh invention for solving the problem, there is provided a portable terminal which displays browsing information by obtaining the browsing information from a server communicably connected via a network, the portable terminal being configured to: receive transmitter identification information included in a wireless signal transmitted from one or more transmitters disposed in association with any one of one or more target areas set in advance toward the corresponding target area, confirm necessity of a browsing restriction on the browsing information based on a combination of the transmitter identification information and terminal identification information which is identification information of the portable terminal, and obtain the browsing information via the server in a case where it is confirmed that the browsing restriction is unnecessary.

In this manner, since the necessity of the browsing restriction on the browsing information is confirmed based on the combination of the transmitter identification information included in the wireless signal from the transmitter and the terminal identification information held by the portable terminal, regarding display of the browsing information on the portable terminal, it is possible to impose a browsing restriction on a person who does not have a browsing authorization with a simple configuration while avoiding a hindrance to easy access to the browsing information.

Hereinafter, embodiments according to the present disclosure will be described with reference to drawings.

### First Embodiment

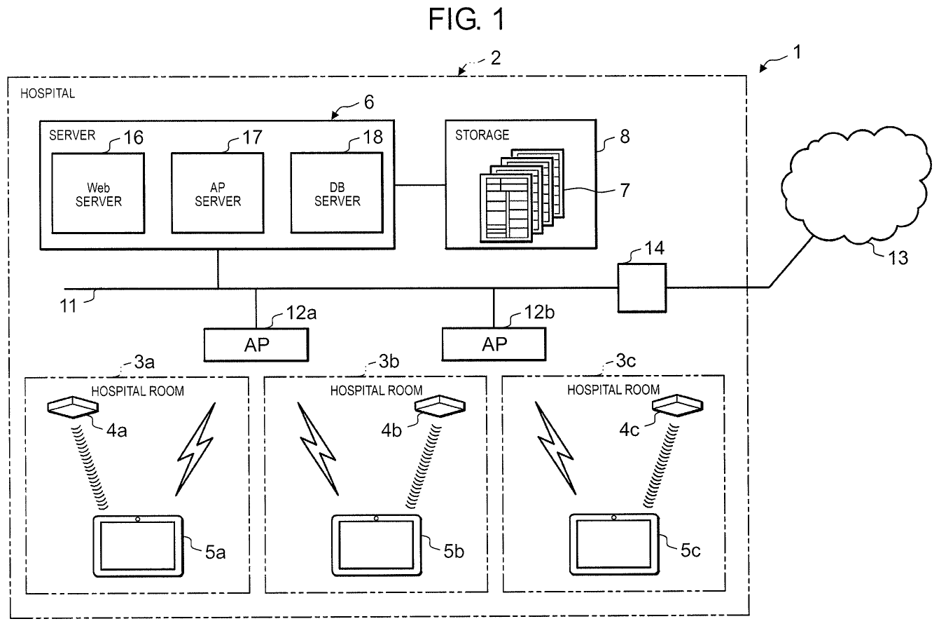

FIG. 1 is an overall configuration diagram of information browsing system 1 according to the first embodiment of the present disclosure.

Information browsing system 1 is a system capable of browsing own medical information (browsing information) of a patient to the patient (not illustrated) who uses each of hospital rooms (target areas) 3a to 3c in a building of hospital 2. Here, the medical information of the patient is not limited to information related to an examination, nursing, a checkup, a treatment, or the like of the patient in hospital 2, for example, and may include any information which may be required by the patient in hospital 2.

In addition, information browsing system 1 mainly includes beacons (transmitters) 4a to 4c which transmit beacon signals, portable terminals 5a to 5c which can receive the beacon signal from beacons 4a to 4c, server 6 which provides the medical information of the patient to portable terminals 5a to 5c, and storage 8 which accumulates the displayable medical information of the patient on portable terminals 5a to 5c as electronic medical record 7.

Further, in information browsing system 1, LAN 11 is constructed as a network which communicably connects each of portable terminals 5a to 5c and server 6. Wireless access point (AP) 12a and 12b which enables wireless connection to LAN 11 of each of portable terminals 5a to 5c based on a well-known wireless communication standard (for example, IEEE 802.11a/b/g/n) or router 14 which relays communication with public network 13 such as an internet are provided at an appropriate place of LAN 11.

It is not necessary to assign each of wireless access points 12a and 12b to each of hospital rooms 3a to 3c one by one and wireless access points 12a and 12b can be commonly used for wireless communication by portable terminal 5 in a plurality of hospital rooms or an area outside the hospital room (passage or the like).

In the following description, in a case where it is not necessary to particularly distinguish hospital rooms 3a to 3c, beacons 4a to 4c, portable terminals 5a to 5c, and wireless access points 12a and 12b, hospital rooms 3a to 3c, beacons 4a to 4c, portable terminals 5a to 5c, and wireless access points 12a and 12b are respectively referred to as hospital room 3, beacon 4, portable terminal 5, and wireless access point 12.

Hospital room 3 is a room respectively accommodating inpatients, and portable terminal 5 usable by each of the patients (that is, the patient is regarded as a user) is assigned to each of hospital rooms 3.

In the present embodiment, for convenience of description, one portable terminal is assigned to a single room in which one inpatient is accommodated in one hospital room, but the configuration is not necessarily limited thereto. For example, a shared room, in which a plurality of divided spaces (bed installation spaces partitioned by a curtain and the like) are provided in one hospital room and one patient is accommodated for each space, also can have a configuration in which one portable terminal is assigned to each of the patients.

Beacon 4 has the same known configuration as each other and is installed at an appropriate place (for example, a ceiling or a wall) of corresponding hospital room 3, and transmits a beacon signal toward each of hospital rooms 3 by broadcasting. The beacon signal is a wireless signal based on a well-known short-distance wireless communication standard (for example, Bluetooth (registered trademark)), and the beacon signal includes a beacon ID (transmitter identification information) as information for identifying each of beacons 4.

In the present embodiment, for convenience of description, one beacon 4 is installed in one hospital room. However, in the case where the plurality of divided spaces are provided in one hospital room as described above, it is also possible to have a configuration in which a plurality of beacons, to which different beacon IDs are assigned, are installed in one hospital room. Alternately, in order to further enlarge an area, in which a radio wave of the beacon is transmitted, in one hospital room, it is also possible to have a configuration in which the plurality of beacons, to which the same beacon ID is assigned, are installed in one hospital room. In addition to beacon 4 of hospital room 3, in hospital 2, it is also possible to install a beacon at an appropriate place (for example, a passage such as a corridor connecting each of hospital rooms 3) in hospital 2.

Further, as long as a transmitter has a configuration of transmitting a beacon signal (that is, a beacon ID) which can be received by at least portable terminal 5 toward a desired target area (here, in each of hospital rooms 3), the various transmitters can be used as beacon 4. In addition, it is also possible to integrate a transmitter used by information browsing system 1 with wireless access point 12 and to respectively dispose wireless access points 12 added with functions capable of transmitting the same beacon signal as beacon 4 in hospital rooms 3. Further, by using a battery-driven transmitter which is not connected (that is, independent from a network used for a browse of browsing information) to LAN 11 like beacon 4, it is possible to increase a degree of freedom of installation and to reduce an installation cost as compared with the case where a network device such as wireless access point 12 or the like is installed in each of hospital rooms 3.

Portable terminal 5 is a portable information device (a mobile phone including a smartphone, a tablet PC, a PDA, or the like) having a wireless communication function based on a well-known wireless communication standard (for example, IEEE 802.11a/b/g/n) and a function of receiving a beacon signal transmitted from beacon 4, and is usually exclusively owned by a specific patient (a user). An application software (a web browser or an exclusive software for browsing) for browsing the medical information to the patient is installed in portable terminal 5. In addition, portable terminal 5 holds (stores) a terminal ID (terminal identification information) which is own identification information. In the present embodiment, a media access control address (MAC address) is used as a terminal ID, but the terminal ID is not limited thereto. For example, unique identification information obtained from the application software may be used as the terminal ID.

Server 6 is operated by an administrator of information browsing system 1 and can provide medical information in response to a request from portable terminal 5 which is a client. Server 6 includes web server 16, application (AP) server 17, and database (DB) server 18 as a software of executing an information provision process for providing medical information to portable terminal 5.

In information browsing system 1, server 6 which provides the medical information includes not only a device actually referred to as a server but also a similar information device (an information provision device) having the same function as the device. In addition, server 6 may be communicably connected to at least portable terminal 5, and a configuration of a network intervening in these communications is not limited thereto. For example, a configuration in which server 6 (including storage 8) is installed outside hospital 2 and is communicably connected to portable terminal 5 via public network 13 (or an exclusive line (not illustrated)) is also possible.

Further, in the present embodiment, electronic medical record 7 includes a record (also excluding information predetermined not to be browsed to the patient) such as a condition, a treatment, a course, or the like of the patient used for a health professional or information (for example, information on bathing, a meal, a medication, information on health, exercise, a weight, a blood pressure or the like of the patient, any information recorded by the patient or a health professional, or the like) which may be required for the patient in hospital 2 as medical information which can be browsed by the patient. The medical information provided to the patient is not entire information included in electronic medical record 7 but is a part of the information included in electronic medical record 7. In addition, the medical information provided to the patient also includes other electronic information associated with the information of electronic medical record 7.

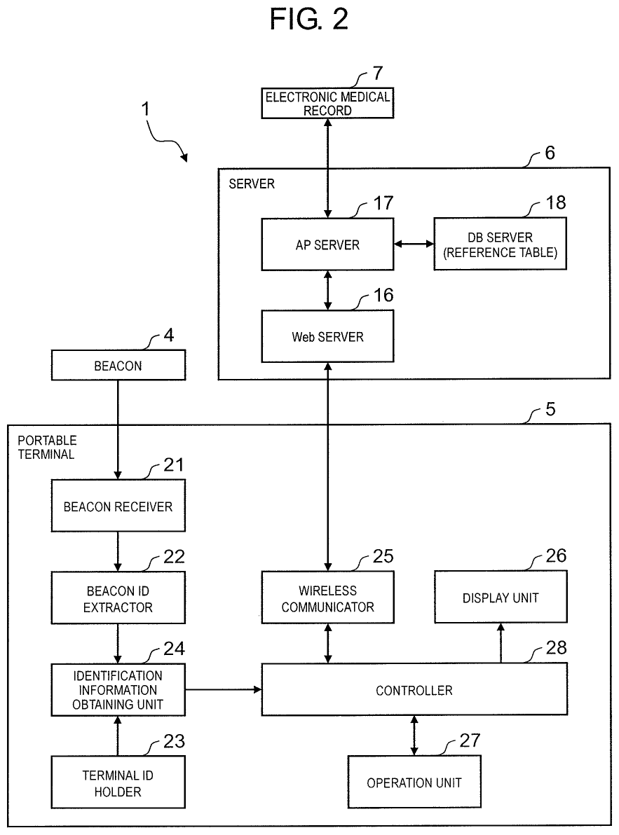

FIG. 2 is a functional block diagram of information browsing system 1.

Portable terminal 5 includes beacon receiver 21 which receives a beacon signal from beacon 4, beacon ID extractor 22 which extracts a beacon ID included in the beacon signal by processing the received beacon signal, terminal ID holder 23 which holds information of a terminal ID (here, a MAC address), identification information obtaining unit 24 which obtains the beacon ID extracted by beacon ID extractor 22 and the information of the terminal ID held by terminal ID holder 23 as identification information to be transmitted to server 6, wireless communicator 25 which communicates with server 6 via wireless access point 12, display unit 26 which displays medical information provided from server 6, operation unit 27 which is used for an input operation (including a touch input) of a user (here, a patient) of portable terminal 5, and controller 28 which executes an information browsing process by generally controlling each of units of portable terminal 5.

In addition, in server 6, web server 16 processes a request from portable terminal 5 by communicating with portable terminal 5, and stores and provides an application software for browsing the medical information in portable terminal 5. Application server 17 executes a process according to the request from portable terminal 5 so as to transmit requested browsing information to portable terminal 5. Database server 18 manages data or information required for the process by application server 17. As described below, application server 17 also functions as a determiner which determines whether or not to cause portable terminal 5 to display the medical information.

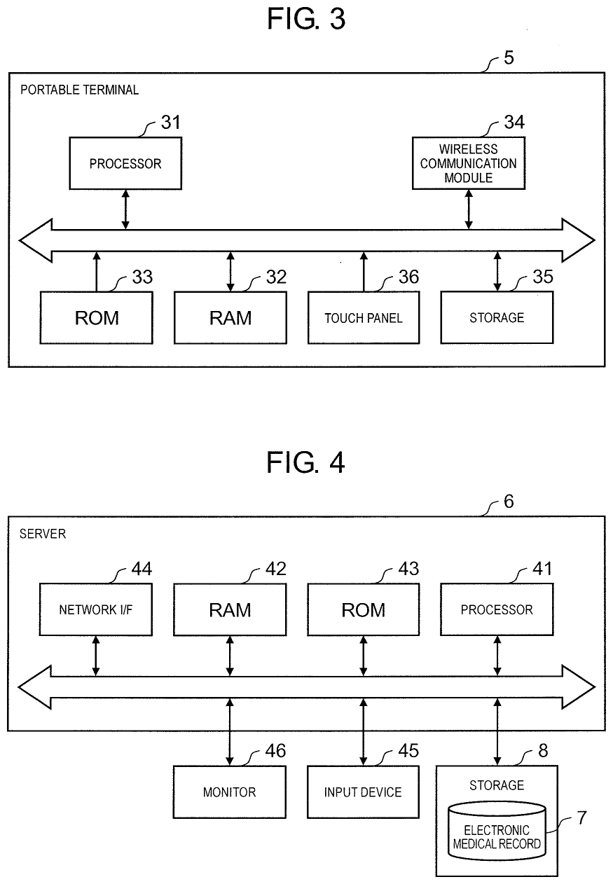

FIGS. 3 and 4 are respective hardware configuration diagrams of portable terminal 5 and server 6 in information browsing system 1.

As illustrated in FIG. 3, portable terminal 5 has a well-known hardware configuration, and includes processor 31 which generally executes various processes required for using information browsing system 1 based on a predetermined control program (an application software for executing the information browsing process), random access memory (RAM) 32 which is a volatile memory which functions as a work area or the like of processor 31, read only memory (ROM) 33 which is a non-volatile memory which stores the control program executed by processor 31 or data, wireless communication module 34 which executes wireless communication via wireless access point 12 and receives a beacon signal from beacon 4, storage 35 which is a programmable ROM which stores the control program or data related to a process of the control program, touch panel 36 which is used for display of the browsing information to the patient (the user) and an operation input from the patient, and the like.

Various functions of portable terminal 5 including each of the functions illustrated in FIG. 2 can be realized by each hardware illustrated in FIG. 3 or by processor 31 executing a predetermined control program in the hardware configuration. Further, in portable terminal 5, the process of receiving the beacon signal (or obtaining the beacon ID) from beacon 4 also can be executed by another known application software separately from the application software which executes the information browsing process.

In addition, as illustrated in FIG. 4, server 6 has a well-known hardware configuration, and includes processor 41 which generally executes a process for providing medical information in response to a request from portable terminal 5 based on a predetermined control program (an application software for executing the information provision process), RAM 42 which is a volatile memory which functions as a work area or the like of processor 41, ROM 43 which stores the control program executed by processor 41 or data, network interface (I/F) 44 which includes a network adapter for communicably connecting with LAN 11, and the like. Further, as peripheral devices, server 6 is provided with input device 45 which is an input device such as a keyboard and a mouse, monitor 46 which includes a liquid crystal monitor and the like, storage 8 which includes an HDD or a flash memory, and the like.

Various functions of server 6 including each of the functions illustrated in FIG. 2 can be realized by each hardware illustrated in FIG. 4 or by processor 41 executing a predetermined control program in the hardware configuration.

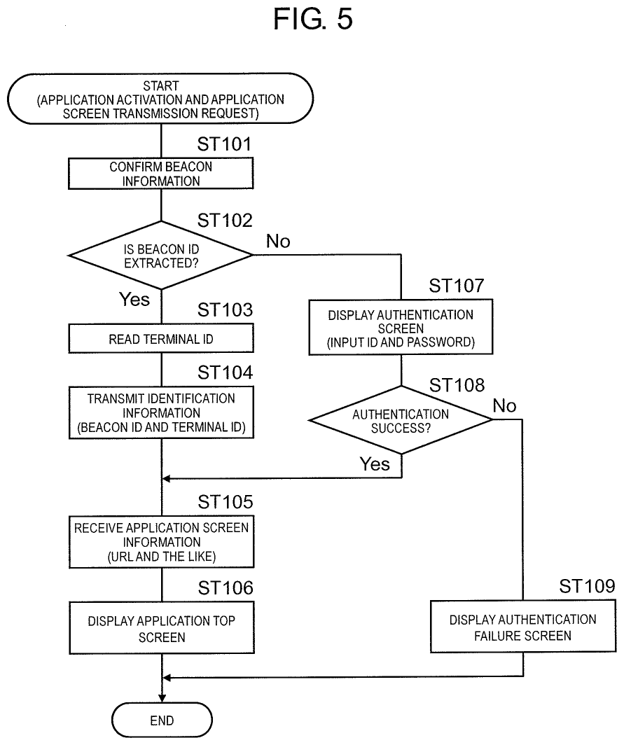

FIG. 5 is a flowchart illustrating a flow until a browsing operation start in an information browsing process in portable terminal 5.

The information browsing process is started by the patient activating a web application software of portable terminal 5 (hereinafter, referred to as “application for browsing”) at a place at which the beacon signal can be received (in this case, hospital room 3). At this time, portable terminal 5 accesses to server 6 and requests that data of a top screen of the application is transmitted.

Subsequently, portable terminal 5 confirms beacon information (that is, information based on the beacon signal received from beacon 4) (ST101). The beacon information is confirmed based on the beacon signal received by a process of the application for browsing after the application for browsing is activated, but the confirmation is not limited thereto. The beacon information may be confirmed based on a beacon signal (that is, regardless of the operation of the application for browsing) received by a process of another application software for receiving the beacon signal. Further, in the process by other application software, a beacon signal may be received before the application for browsing is activated.

Next, portable terminal 5 extracts a beacon ID from the received beacon signal, and in a case where the beacon ID can be normally extracted (Yes in ST102), portable terminal 5 further reads a terminal ID held by portable terminal 5 (ST103).

Next, portable terminal 5 transmits identification information including the extracted beacon ID and the read terminal ID to server 6 (ST104). When server 6 normally receives the identification information, portable terminal 5 can obtain information (URL information or the like for displaying a top screen of the application for browsing) of the application top screen from server 6 (ST105). Accordingly, portable terminal 5 displays the application top screen on display unit 26 (that is, touch panel 36) (ST106). After then, the patient can browse medical information of the patient by using the application top screen, and can display and browse a desired screen which can be transitioned from the application top screen one by one.

In addition, in step ST102, in a case where the beacon ID cannot be normally extracted (No), portable terminal 5 displays an authentication screen of the user prepared in advance on display unit 26 (ST107). Here, as described below, the patient is requested to input a user ID and a password of the patient by the authentication screen of the user. When authentication of the patient (identity certification) is normally performed in server 6 (Yes in ST108), the process proceeds to step ST105 in the same manner as in the case where server 6 normally receives the identification information described above.

As described above, in information browsing system 1, in the case where it is not possible to obtain the beacon ID, it is determined that the medical information cannot be displayed on portable terminal 5 as it is and the user authentication is executed, so that it is possible to more easily impose a browsing restriction. In addition, as described above, by allowing the browsing operation of an authorized user (including a health professional who has a browsing authorization other than the patient) by using the authentication screen of the user as an exception of the browsing restriction, it is possible to improve convenience of displaying the browsing information on portable terminal 5 while sacrificing the simple access to the browsing information to some extent.

On the other hand, in step ST108, in a case where the authentication of the user is not normally performed (No), portable terminal 5 displays an authentication failure screen indicating that the authentication is failed, on display unit 26 (ST109). Accordingly, it is possible to impose the browsing restriction on a person who does not have a browsing authorization on the medical information. Here, although the authentication failure screen is displayed in step ST109, the present embodiment is not limited to this configuration. For example, portable terminal 5 can execute a process for prohibiting transition of the currently displayed screen or can display a warning screen for unauthorized browsing.

In addition, in step ST102 described above, in a case where the beacon ID cannot be normally extracted (No), it is also possible to forcibly terminate the information browsing process without executing the authentication process of the user (steps ST107 to ST109) as described above.

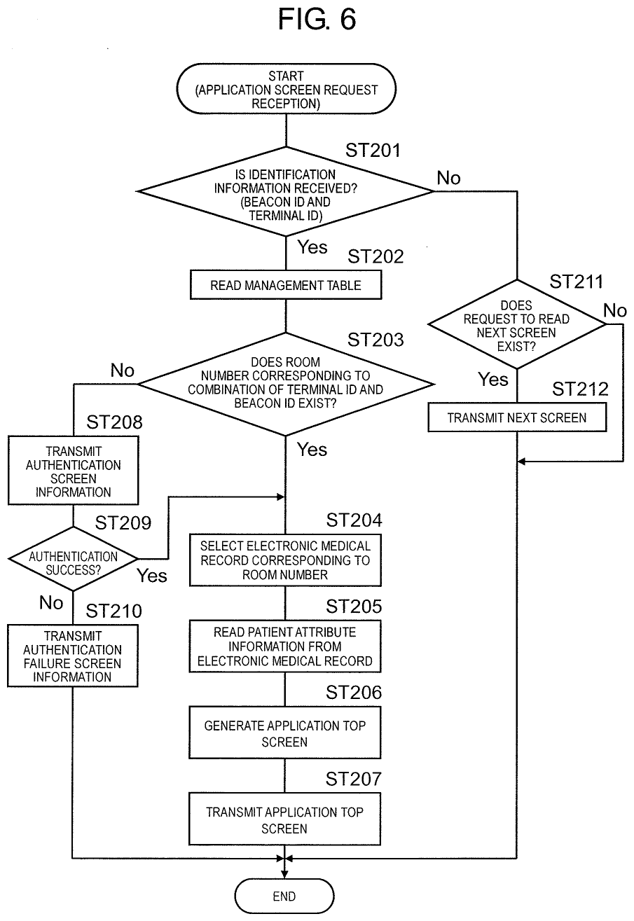

FIG. 6 is a flowchart illustrating a flow until an information provision start in an information provision process of the server.

The information provision process is started when server 6 receives a request to transmit data on an application top screen from portable terminal 5. After then, when receiving identification information including a beacon ID and a terminal ID transmitted from portable terminal 5 (Yes in ST201), server 6 executes reading of a management table so as to determine whether or not to display medical information on portable terminal 5 based on the identification information (ST202). As described in detail below, in the management table (a first management table), regarding permission area information indicating a target area for which browsing of the medical information is permitted, one or more combinations of the beacon ID and the terminal ID used in hospital 2 are registered. Here, a room number assigned to each of hospital rooms 3 is used as the permission area information. The management table is not limited to the configuration illustrated in the present embodiment, and the management table can be stored in any storage or the like including an external storage.

Next, in order to determine whether or not to display the medical information on portable terminal 5, server 6 refers to the management table. In a case where a room number corresponding to a combination of the beacon ID and the terminal ID received in step ST201 described above exists (that is, it is determined that the medical information is to be displayed) (Yes in ST203), server 6 selects one electronic medical record by using the room number corresponding to the combination from plurality of electronic medical records 7 stored in storage 8 (ST204).

Subsequently, server 6 obtains attribute information (user attribute information) of the patient from the electronic medical record selected in step ST204 described above (ST205). The attribute information of the patient includes, for example, information such as a name, a room number, a sex, a birth date, a hospitalization date (a start date), and the like of the patient.

Next, server 6 generates an application top screen on which the attribute information of the patient obtained in step ST205 described above is displayed, and transmits data on the generated application top screen to portable terminal 5 (ST207). After then, server 6 starts providing information in response to a request (an information transmission command) from portable terminal 5 based on the browsing operation of the patient, appropriately extracts necessary information from the electronic medical record selected in ST204 described above, and transmits the information to portable terminal 5.

In this manner, since server 6 determines whether or not to display the medical information on portable terminal 5 based on the combination of the beacon ID included in the beacon signal from beacon 4 and the terminal ID held by portable terminal 5, regarding display of the medical information in portable terminal 5, server 6 can impose a browsing restriction on a person who does not have a browsing authorization with a simple configuration while avoiding a hindrance to easy access to the medical information (for example, without requiring an input of a password for confirming the browsing authorization, reading an IC tag, or the like).

In addition, in server 6, since the medical information included in electronic medical record 7 selected according to the room number as the permission area information is transmitted to portable terminal 5, portable terminal 5 can rapidly access to the medical information. Further, since the application top screen (the medical information) transmitted from server 6 to portable terminal 5 includes the attribute information of the patient, it is possible for the patient to easily confirm that the information to be browsed is own information of the patient.

In addition, in a case where the room number corresponding to the combination of the beacon ID and the terminal ID does not exist in the management table (No in ST203), server 6 transmits data on the authentication screen of the user prepared in advance to portable terminal 5 (ST208). When the authentication of the patient is normally completed in server 6 by the authentication operation of the patient in portable terminal 5 (here, the input of the user ID and the password and transmission of the user ID and the password to server 6) (Yes in ST209), the process proceeds to step ST204 in the same manner as in the case where the room number exists in the management table. Although the authentication operation is performed by the patient, a personnel of the hospital such as a doctor or a nurse carries portable terminal 5, uses the user ID and the password of the personnel to search for the patient, and browses medical record information. Even in such a case, the personnel can perform an input operation of the user ID and the password from the authentication screen of the user transmitted from server 6, so that the medical record information of the patient by portable terminal 5 can be browsed.

On the other hand, in a case where the authentication of the patient is not normally completed in server 6 (No in ST209), server 6 transmits data related to the authentication failure screen indicating that the authentication is failed, to portable terminal 5 (ST210). Accordingly, it is possible to impose the browsing restriction on a person who does not have a browsing authorization on the medical information. Here, although the authentication failure screen is transmitted in step ST210, the present embodiment is not limited to this configuration. For example, as described above, server 6 also can transmit the warning screen for unauthorized browsing to portable terminal 5.

In addition, in a case where the identification information is not received (No in ST201), server 6 further determines whether or not there is a request to read the next screen which can be transitioned from the current display screen of portable terminal 5. In a case where the read request exists (ST211), the data on the requested next screen is transmitted to portable terminal 5 (ST212). On the other hand, in a case where there is no request to read the next screen (No in ST211), server 6 terminates series of processes as it is.

In a case where the room number corresponding to the combination of the beacon ID and the terminal ID does not exist in the management table (No in ST203), it is also possible to forcibly terminate the information provision process without executing the authentication process of the user (steps ST208 to ST210) as described above.

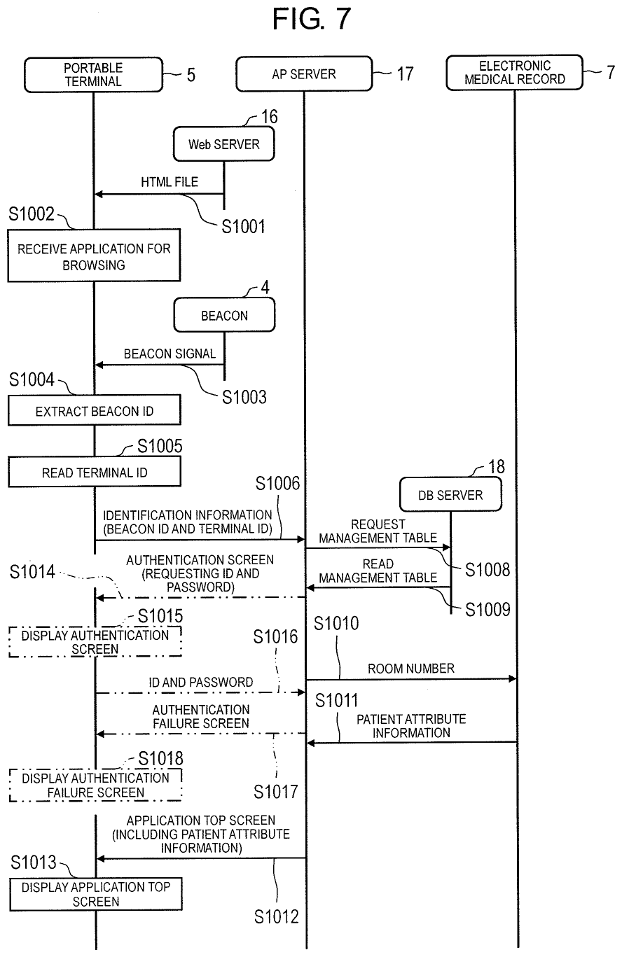

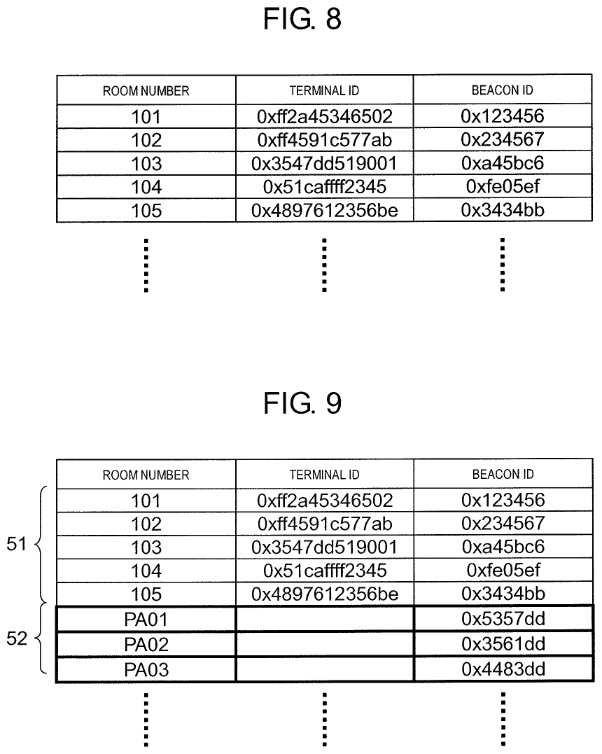

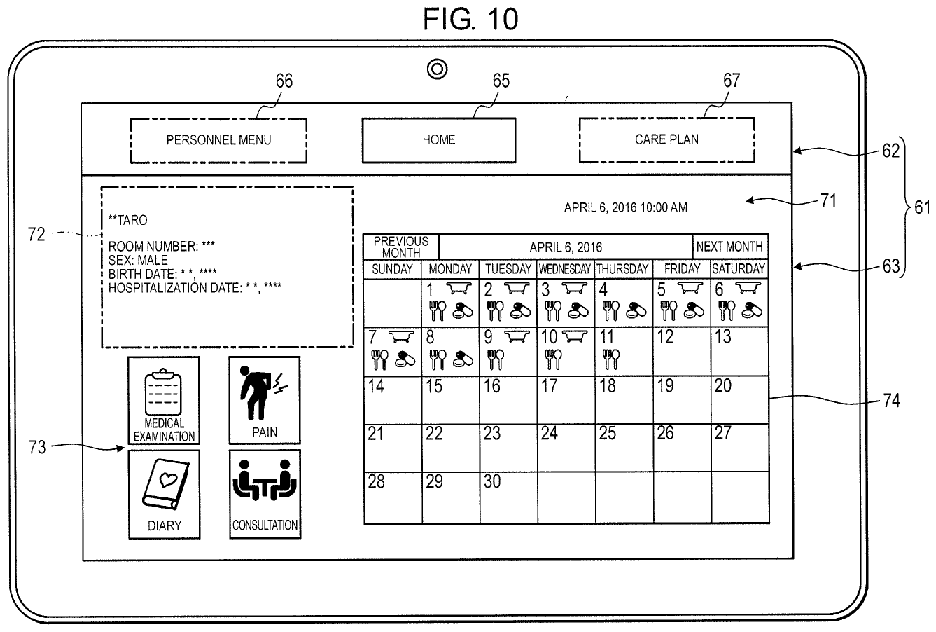

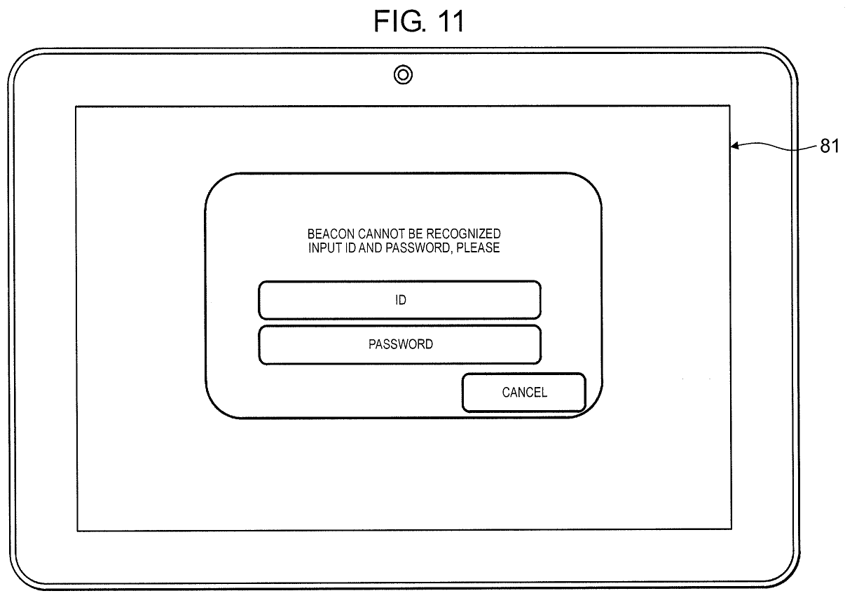

FIG. 7 is a sequence diagram illustrating a process such as communication or the like of each of units until an information provision start in information browsing system 1. FIG. 8 is an explanatory diagram illustrating an example of a management table related to 51008 in FIG. 7. FIG. 9 is an explanatory diagram illustrating a modification example of the management table illustrated in FIG. 8. FIG. 10 is an explanatory diagram illustrating an example of an application top screen related to 51013 in FIG. 7. FIG. 11 is an explanatory diagram illustrating an example of an authentication screen related to S1015 in FIG. 7.

First, in FIG. 7, portable terminal 5 receives an application for browsing based on an HTML file (S1001) transmitted from server 6 in response to a request to server 6 (S1002). Subsequently, portable terminal 5 receives a beacon signal from beacon 4 of hospital room 3 (S1003), and extracts a beacon ID from the received beacon signal (S1004). Further, portable terminal 5 reads a terminal ID held by portable terminal 5 (S1005), and transmits identification information including the beacon ID and the terminal ID to server 6 (S1006).

When receiving the identification information from portable terminal 5 (S1007), application server 17 requests a management table (not illustrated) to database server 18 to determine whether or not to display medical information on portable terminal 5 based on the identification information (S1008) and reads the management table (S1009).

Here, in the management table (the first management table) illustrated in FIG. 8, a combination of the beacon ID and the terminal ID is registered for a room number indicating a target area for which browsing of the medical information is permitted.

For example, according to the management table illustrated in FIG. 8, in hospital room 3 to which a room number of 101 is assigned, when receiving a beacon ID of “0x123456”, portable terminal 5 having a terminal ID of “0xff2a45346502” can be used for browsing medical information of a patient of the room number of 101. Therefore, in a case where portable terminal 5 having the terminal ID of “0xff2a45346502” receives a message other than the beacon ID of “0x123456” in the room number of 101, it is determined that the medical information is not displayed, and browsing of the medical information is not permitted in portable terminal 5.

In this manner, when determining whether or not to display the medical information on portable terminal 5, since the combination of the beacon ID and the terminal ID registered in the management table is referred to, it becomes easy to manage a browsing restriction (browsing permission) on each of the target areas.

In addition, as illustrated in FIG. 9 as an alternative, only a beacon ID can be registered (a terminal ID is unregistered) for a passage number as prohibition area information indicating a target area for which browsing of medical information is prohibited in the management table (a second management table).

For example, according to the management table illustrated in FIG. 9, in a passage to which a passage number of “PA01” is assigned, when receiving a beacon ID of “0x5357dd”, portable terminal 5 cannot be used for browsing medical information of the patient. That is, since the terminal ID for the beacon ID of “0x5357dd” is not registered in the management table, it is determined that the medical information is not displayed, and browsing of the medical information is permitted in portable terminal 5.

In this manner, when determining whether or not to display the medical information on portable terminal 5, since the management table in which only the beacon ID is registered is referred to, it becomes easy to manage a browsing restriction (browsing prohibition) for each of the target areas.

Although the management table illustrated in FIG. 9 includes permission area field 51 including the same permission area information as in the case in FIG. 8 and prohibition area field 52 including prohibition area information, the present embodiment is not limited to this configuration. The management table may include only prohibition area field 52. In addition, in the management table illustrated in FIG. 8, the combination of the beacon ID and the terminal ID is registered for the room number. Instead of the room number, a combination of the beacon ID and the terminal ID may be registered for a patient designation name, a medical record number, or the like.

Next, referring to the read management table, application server 17 obtains a room number corresponding to the combination of the beacon ID and the terminal ID included in the identification information received from portable terminal 5, accesses to corresponding electronic medical record 7 based on the room number (S1010), and obtains attribute information of the patient from the electronic medical record (S1011). Here, the beacon ID is associated with the room number of hospital room 3 in which beacon 4 having the beacon ID is installed, and the room number of hospital room 3 is associated with electronic medical record 7 of the patient who uses hospital room 3.

Subsequently, application server 17 transmits data related to an application top screen on which the attribute information of the patient included in the electronic medical record is displayed to portable terminal 5 (S1012). Accordingly, portable terminal 5 displays the application top screen on display unit 26 (S1013). After then, the patient can browse the medical information of the patient by using the application top screen, and can display and browse a desired screen which can be transitioned from the application top screen one by one.

Here, as illustrated in FIG. 10, application top screen 61 includes, for example, menu display area 62 in which a plurality of selection menus are displayed and information display area 63 in which medical information and the like of a patient is displayed.

The selection menu set to menu display area 62 includes home 65 for the patient to browse the medical information and the like, personnel menu 66 for displaying information for a health professional (an administrator of information browsing system 1) in hospital 2, and care plan 67 for displaying a plan of a nursing service for the target patient to the health professional in a case where the patient is a patient to be nursed. Personnel menu 66 and care plan 67 are selection menus used only by the health professional and by these selection menus, it is possible for the health professional as well as the patient to use portable terminal 5. Personnel menu 66 and care plan 67 (or entire menu display area 62) may be omitted and portable terminal 5 may be used only by the patient.

In information display area 63, information 71 of current date and time, patient attribute information 72, plurality of patient menu buttons 73 executable by the patient, and calendar 74 capable of displaying a schedule of the patient in hospital 2 are included.

In the present embodiment. patient menu button 73 includes a button of “medical examination form” capable of entering a medical examination form (an electronic file) submitted from the patient to hospital 2, a button of “diary” to which the patient can enter a daily event, a button of “pain” capable of recording a pain and the like caused in an affected part by the patient, a button of “consultation” to which the patient can enter contents (excluding urgent contents) which the patient wishes to consult with a doctor or a nurse, and the like. The patient can execute a desired patient menu by pressing these buttons.

In addition, the patient can use calendar 74 to display a past result related to bathing, a meal, a medication (a management situation of medicine), a plan from now on, and the like of the patient.

On the other hand, in a case where the room number cannot be obtained even when referring to the management table read from database server 18 in step S1008 described above, application server 17 can transmit data related to the authentication screen of the user for a request for the patient inputting the user ID and the password, to portable terminal 5 (S1014). Accordingly, portable terminal 5 can display authentication screen 81 (see FIG. 11) on display unit 26 based on the data on the authentication screen received from server 6 (S1015) and can prompt the patient to input the user ID and the password. Portable terminal 5 can transmit the user ID and the password input by the patient (or the health professional or the like in hospital 2 which is an administrator of information browsing system 1) to application server 17 (S1016).

When the authentication of the patient is normally performed, in the same manner as in the case described above, application server 17 transmits data related to the application top screen to portable terminal 5 (S1012). On the other hand, if the authentication of the patient is not performed normally, server 6 can transmit data related to the authentication failure screen to portable terminal 5 (S1017). Accordingly, portable terminal 5 can display the authentication failure screen on display unit 26 based on the screen data received from server 6 (S1018).

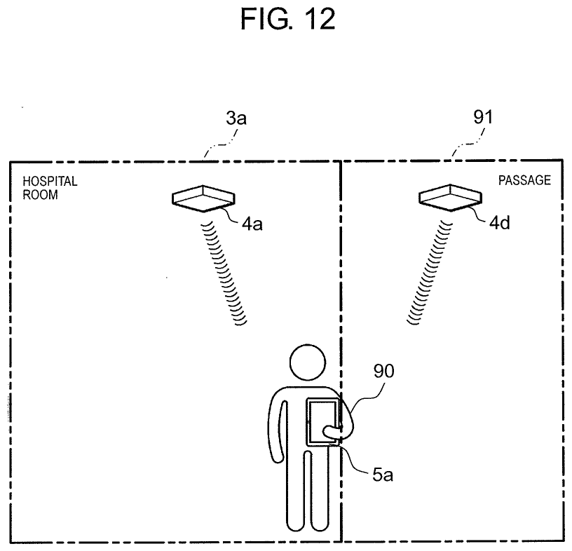

FIG. 12 is an explanatory diagram illustrating an example of a case where the portable terminal receives a plurality of beacon signals.

As illustrated in FIG. 12, for example, in a case where patient 90 who uses portable terminal 5 is positioned between hospital room 3a and passage 91, portable terminal 5a may receive beacon signals from both of beacon 4a installed at hospital room 3a and beacon 4d installed on a side of passage 91. In this case, when extracting a beacon ID by portable terminal 5a described above (see step ST102 in FIG. 5 and S1004 in FIG. 7), a plurality of beacon IDs are extracted.

At this time, portable terminal 5a may refer to radio wave intensities of the beacon signals corresponding to these beacon IDs, select one beacon ID included in beacon 4a having a larger radio wave intensity, and transmit the beacon ID as identification information together with the terminal ID to server 6.

In this manner, in information browsing system 1, even in a case where portable terminal 5 receives the beacon signals from the plurality of different beacons 4, it is possible to set a priority order based on a magnitude of the radio wave intensity of the beacon signal and it becomes possible to stably impose a browsing restriction by selecting one beacon ID according to the priority order.

As another method, when the plurality of beacon IDs are extracted, portable terminal 5a can also transmit the plurality of beacon IDs together with the terminal ID to server 6 as identification information. In this case, server 6 refers to the management table (see step ST203 in FIGS. 6 and S1009 in FIG. 7). In a case where at least one beacon ID for which permission area information is not associated exists in the plurality of beacon IDs, server 6 determines that authentication of the user is necessary (the medical information cannot be displayed on portable terminal 5) and can transmit data related to the authentication screen of the user to portable terminal 5.

In addition, in a case where a plurality of the beacon IDs used for determining whether or not to display the medical information on portable terminal 5 exists and prohibition area information associated with at least one of the plurality of beacon IDs is included in the area management table, information browsing system 1 determines that the medical information is not displayed on portable terminal 5 and can realize a stable browsing restriction on the target area in which browsing of the medical information is prohibited. In a case where the plurality of beacon IDs are transmitted from portable terminal 5 to server 6, server 6 also may select a beacon ID to be executed in portable terminal 5 described above.

### Second Embodiment

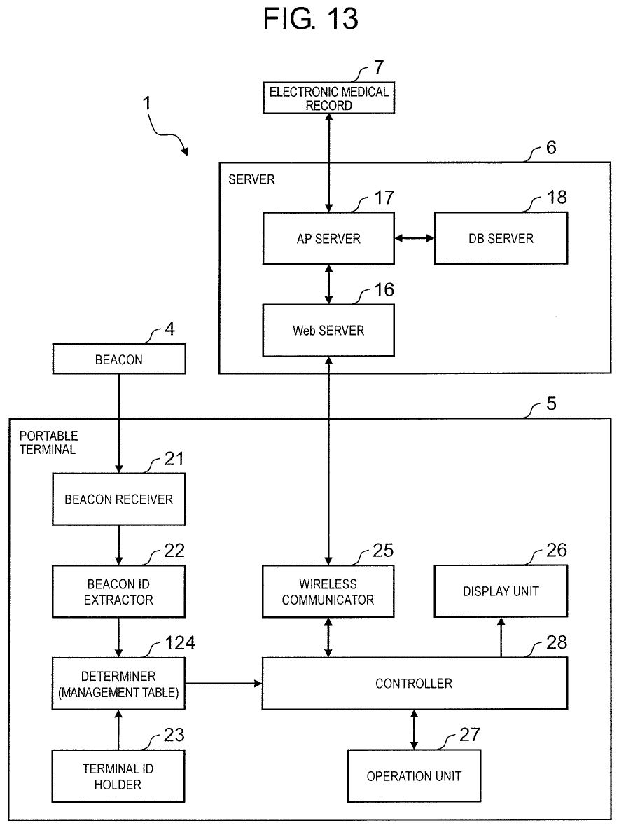

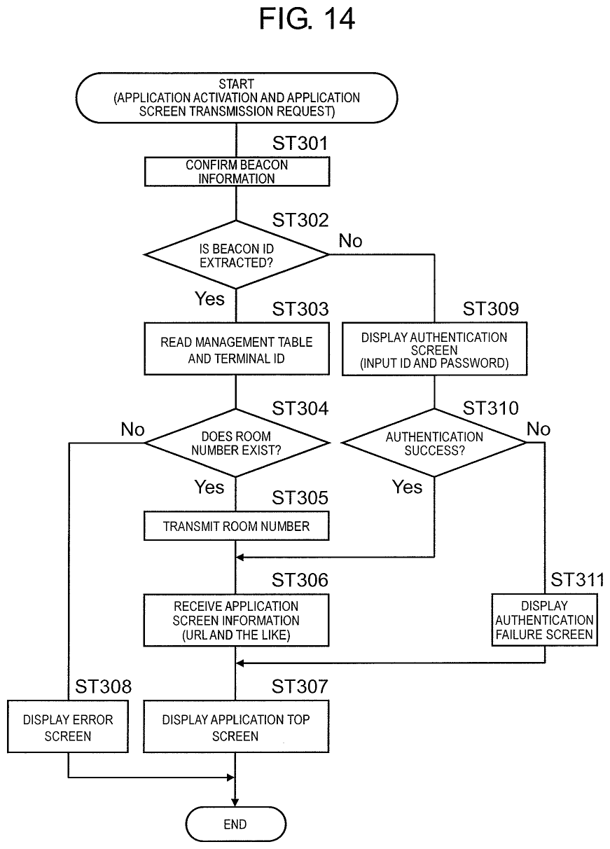

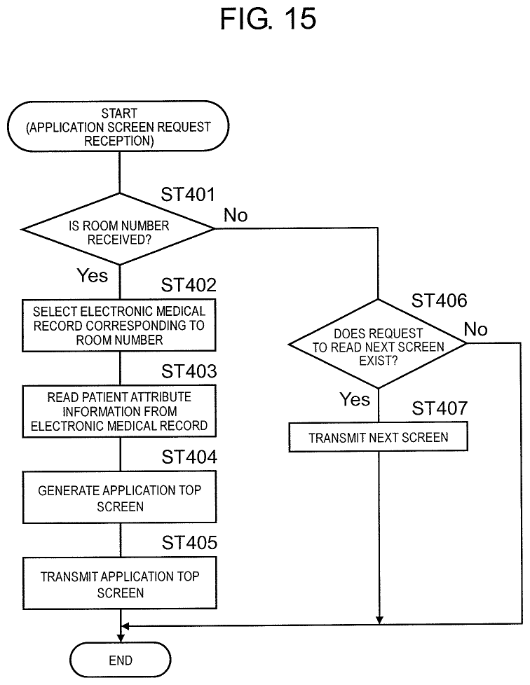

FIG. 13 is a functional block diagram of information browsing system 1 according to the second embodiment of the present disclosure and corresponds to FIG. 2 described above. In FIG. 13 (in the same manner as FIG. 14 and FIG. 15), the same components as those of the first embodiment described above are denoted by the same reference numerals. In addition, in information browsing system 1 according to the second embodiment, details not specifically mentioned below are similar to those of the first embodiment described above, and a detailed description thereof will be omitted.

Information browsing system 1 according to the second embodiment is different from the first embodiment described above in that determiner 124 is provided instead of identification information obtaining unit 24 in portable terminal 5 illustrated in FIG. 2.

Portable terminal 5 holds the same management table as the management table accumulated in server 6 in information browsing system 1 according to the first embodiment. When obtaining information of a beacon ID extracted by beacon ID extractor 22 and a terminal ID held in terminal ID holder 23 as identification information, determiner 124 refers to the management table to determine whether or not a room number corresponding to a combination of the beacon ID and the terminal ID exists (that is, whether or not to display medical information on portable terminal 5). Further, determiner 124 transmits the determination result (here, information of a room number) to server 6 instead of the identification information in the first embodiment.

FIG. 14 is a flowchart illustrating a flow until a browsing operation start in an information browsing process in the portable terminal according to the second embodiment. Here, steps ST301, ST302, ST306, ST307 and ST309 to ST311 respectively correspond to ST101, ST102, and ST105 to ST109 in FIG. 5.

In FIG. 14, in a case where the beacon ID can be normally extracted (Yes in ST302), portable terminal 5 further reads the management table and the terminal ID held by portable terminal 5 (ST303).

Next, by referring to the management table, portable terminal 5 determines whether or not a room number corresponding to the combination of the extracted beacon ID and the read terminal ID exists (ST304), and in a case where the room number exists(Yes in ST304), portable terminal 5 obtains information of the room number (that is, it is determined that the medical information is displayed on portable terminal 5) and transmits the information to server 6 (ST305).

On the other hand, in a case where the information of the room number does not exist (No in ST304), portable terminal 5 displays an error screen indicating that medical information cannot be browsed (alternately, the beacon signal cannot be received or a current communication position is unauthorized) on display unit 26 (ST308) The other steps are the same as in the case in FIG. 5.

FIG. 15 is a flowchart illustrating a flow until an information provision start in an information provision process of server 6 according to the second embodiment. Here, steps ST402 to ST407 respectively correspond to ST204 to ST207, ST211, and ST212 in FIG. 6.

When the information provision process is started, server 6 determines whether or not the information of the room number is received from portable terminal 5 (that is, whether or not the medical information is displayed on portable terminal 5). In a case of receiving the room number (Yes in ST401), server 6 selects one electronic medical record corresponding to the room number from plurality of electronic medical records 7 stored in storage 8 (ST402). On the other hand, in a case where server 6 does not receive the room number within a predetermined time (No in ST401), the process proceeds to step ST406. The other steps are the same as in the case in FIG. 6.

Although the present disclosure is described based on the specific embodiments, these embodiments are merely examples, and the present disclosure is not limited by these embodiments. For example, in the embodiment described above, the example in which the information browsing system is used for browsing the medical information of the patient in the hospital is described, but the embodiment is not limited thereto. Since any information restricted for browsing (browsing information for a specific user) can be browsed by a user positioned at a target area (indoor or the like) in which a beacon (a transmitter) is installed, the information browsing system also can be used for another facility having a plurality of individual rooms (for example, a nursing care facility, an accommodation, a net cafe, and the like). All of the components of the information browsing system, the information browsing method, and the portable terminal according to the present disclosure described in the embodiment are not necessarily essential, and can be appropriately selected at least without departing from the scope of the present disclosure.

### INDUSTRIAL APPLICABILITY

The information browsing system, the information browsing method, and the portable terminal according to the present disclosure can impose a browsing restriction on a person who does not have a browsing authorization with a simple configuration while avoiding a hindrance to easy access to browsing information and are useful for preventing a leakage of personal information of a user in a facility having a plurality of individual rooms.

### REFERENCE MARKS IN THE DRAWINGS

1 INFORMATION BROWSING SYSTEM

2 HOSPITAL

3 HOSPITAL ROOM

4 BEACON (TRANSMITTER)

5 PORTABLE TERMINAL

6 SERVER

7 ELECTRONIC MEDICAL RECORD

8 STORAGE

12 WIRELESS ACCESS POINT

13 PUBLIC NETWORK

14 ROUTER

16 WEB SERVER

17 APPLICATION SERVER

18 DATABASE SERVER

21 BEACON RECEIVER

22 BEACON ID EXTRACTOR

23 TERMINAL ID HOLDER

24 IDENTIFICATION INFORMATION OBTAINING UNIT

26 DISPLAY UNIT

28 CONTROLLER

31 PROCESSOR

34 WIRELESS COMMUNICATION MODULE

35 STORAGE

36 TOUCH PANEL

41 PROCESSOR

61 APPLICATION TOP SCREEN

62 MENU DISPLAY AREA

63 INFORMATION DISPLAY AREA

72 PATIENT ATTRIBUTE INFORMATION

81 AUTHENTICATION SCREEN

90 PATIENT

91 PASSAGE

1. An information browsing system,. comprising:
one or more transmitters that are disposed in association with any of one or more target areas set in advance and respectively transmit wireless signals including transmitter identification information which is identification information of a corresponding transmitter, toward a corresponding target area;
a portable terminal that holds terminal identification information which is identification information of the portable terminal and receives the a wireless signal;
a storage that accumulates browsing information able to be displayed on the portable terminal; and
a server that provides the browsing information to the portable terminal by communicably connecting to the portable terminal via a network,
wherein at least one of the portable terminal and the server determines whether or not to display the browsing information on the portable terminal based on a combination of the transmitter identification information and the terminal identification information.

2. The information browsing system of claim 1,
wherein regarding permission area information indicating the target area in which the browsing information is permitted to be browsed, the at least one of the portable terminal and the server refers to a first management table in which one or more combinations of the transmitter identification information and the terminal identification information are registered, and determines to display the browsing information on the portable terminal in a case where the combination of the transmitter identification information and the terminal identification information is included in the first management table.

3. The information browsing system of claim 2,
wherein the server transmits browsing information selected according to the permission area information from a plurality of pieces of the browsing information accumulated in the storage, to the portable terminal.

4. The information browsing system of claim 3,
wherein user attribute information of the portable terminal is included in the selected browsing information.

5. The information browsing system of claim 1,
wherein regarding prohibition area information indicating the target area in which the browsing information is prohibited from being browsed, the at least one of the portable terminal and the server refers to a second management table in which one or more pieces of the transmitter identification information are registered, and determines not to display the browsing information on the portable terminal in a case where the transmitter identification information is included in the second management table.

6. The information browsing system of claim 5,
wherein in a case where a plurality of pieces of the transmitter identification information to be used for the determination exist and the at least one of the plurality of pieces of the transmitter identification information is included in the second management table, at least one of the portable terminal and the server determines not to display the browsing information on the portable terminal.

7. The information browsing system of claim 1,
wherein in a case where a plurality of pieces of the transmitter identification information to be used for the determination exist, the at least one of the portable terminal and the server refers to radio wave intensities of the wireless signals including the plurality of pieces of the transmitter identification information respectively and selects one piece of the transmitter identification information included in a wireless signal having a larger radio wave intensity, as information to be used for the determination.

8. The information browsing system of claim 1,
wherein in a case where the at least one of the portable terminal and the server determines not to display the browsing information on the portable terminal, the portable terminal displays an authentication screen of a user.

9. The information browsing system of claim 1,
wherein in a case where the portable terminal is unable to obtain the transmitter identification information, the at least one of the portable terminal and the server determines not to display the browsing information on the portable terminal.

10. An information browsing method comprising:
respectively transmitting, by one or more transmitters disposed in association with any of one or more target areas set in advance, wireless signals including transmitter identification information which is identification information of a corresponding transmitter toward a corresponding target area;
receiving, by a portable terminal that holds terminal identification information which is identification information of the portable terminal, a wireless signal; and
providing, by a server communicably connected to the portable terminal via a network, browsing information to the portable terminal,
wherein before the providing, at least one of the portable terminal and the server determines whether or not to display the browsing information on the portable terminal based on a combination of the transmitter identification information and the terminal identification information.

11. A portable terminal which displays browsing information by obtaining the browsing information via a server communicably connected via a network, the portable terminal being configured to:
receive transmitter identification information included in a wireless signal transmitted from one or more transmitters disposed in association with any one of one or more target areas set in advance toward a corresponding target area,
confirm necessity of a browsing restriction on the browsing information based on a combination of the transmitter identification information and terminal identification information which is identification information of the portable terminal, and
obtain the browsing information via the server in a case where it is confirmed that the browsing restriction is unnecessary.
